(19) United States
(12) Patent Application Publication
(10) Pub. No.: US 2022/0171659 A1
(43) Pub. Date: Jun. 2, 2022

(54) Processing Module, Integrated Development Environment, Methods, and Program Codes

(71) Applicant: Intel Corporation, Santa Clara, CA (US)

(72) Inventors: Tat Kin TAN, Bayan Lepas (MY); Kamarul Zaman ABDUL RASHID, Bayan Lepas (MY)

(21) Appl. No.: 17/643,852

(22) Filed: Dec. 13, 2021

(51) Int. Cl. G06F 9/50; G06F 8/65; G06F 8/71

(52) U.S. Cl. CPC G06F 9/5044; G06F 8/71; G06F 8/65; G06F 9/5011

(57) ABSTRACT

A processing module is provided. The processing module includes one or more interfaces configured to communicate with at least one integrated development environment and processing circuitry configured to control the one or more interfaces. The processing circuitry is further configured to obtain information about at least one hardware microservice of a processing unit, adapt the information about the at least one hardware microservice to a universal format for informing the at least one IDE about the at least one hardware microservice and provide the at least one IDE access to the at least one hardware microservice.

### BACKGROUND

Hardware microservices (also referred as hardware feature) usually offer great performance because they are built to provide specific functions and engrained into the hardware, e.g. a processing unit. However, the hardware microservices are not easily available and hard to access in an end-user application software engineering practices, e.g., the hardware microservices are notoriously difficult to use. The main culprit of this problem is due to the lack of accessibility of the features outside the hardware realm.

In order to tap into the hardware functionality, developers will have to create its own shim layer, software driver or adaptive layer and integrate the hardware microservices into their Integrated Development Environment (IDE) of choice. This creates issues in scalability and manageability. For different IDEs, different native project file or package implementations have to be maintained.

When developers want to share solutions amongst IDEs, it is currently a lack of a design model to share information to allow cross compilation. An individual IDE developer will have to hand-craft its own syntax, model, language in order for the particular IDE to understand what are the layers involved, the structures needed and the sequence of cross-compilation. Linking software components and libraries are resource intensive and require an established and well supported ecosystem. Thus, there may be a need to increase an accessibility of hardware microservices.

### BRIEF DESCRIPTION OF THE FIGURES

Some examples of apparatuses and/or methods will be described in the following by way of example only, and with reference to the accompanying figures, in which

FIG. 1 shows an example of an alternative method for building a custom shim layer;

FIG. 2 shows a block diagram of an example of a processing module;

FIG. 3 shows an example of accessing a desired hardware microservice;

FIG. 4 shows an example of a meta framework;

FIG. 5a-5e show properties within the primary construct and the secondary constructs;

FIG. 6 shows a block diagram of an example of an IDE;

FIG. 7 shows an example of a method;

FIG. 8 shows an example of a method for an IDE;

FIG. 9 shows an example of a processing unit; and

FIG. 10 shows a computing device.

### DETAILED DESCRIPTION

A user of a processing unit may wish to consume the hardware microservices of the processing unit, but there is no easy way to provision and proliferate the hardware microservices across their implementation. For example, there is no ease-of-use software solution of toolchain to provision the hardware microservices. There are many different software code development tools, e.g., IDEs for different software languages offered by the respective software developer, and they all individually serve a purpose that is to encourage and spur a strong software development ecosystem around their technologies and toolchain without a streamlined usage to the hardware microservices.

Thus, a user may be in a need of a common framework that would allow the provision of hardware microservices across the implementation regardless of the IDEs or the development platforms. This way today used IDEs, which cannot access all hardware microservices of a processing unit and cannot coexist in harmony across all IDEs, can be leveraged by a processing module providing full access to all hardware microservices for each IDE. Thus, a unified method to share the hardware microservices, e.g., by use of a hardware microservice construct, among different IDEs can be provided. For example, a developer tool agnostic meta data structure (e.g., comprised by the processing module) to provide easy configuration and harmonization across IDEs can be provided.

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

FIG. 1 shows an example of an alternative method for building a custom shim layer. To generate a custom shim layer for hardware microservice 140 (e.g., to use a Trusted Platform Modules, TPM, Random Number Generator, RNG) in a conventional software application developer situation a plurality of IDEs 110, 111, 112, 113 from different software application developers may be used, each utilizing a different development platform 120, 121, 122, 123. Software Application Developers often develop application in their choice of IDE. For example, an IDE1 110 based software engineer will develop software running on IDE1 platform via IDE1 project 120 which comes with its own IDE 110. Likewise, for an application developer developing software application running on an IDE2 platform, will use IDE2 project 121 and it comes with its own IDE2 111. Each IDE 110, 111, 112, 113 claims to offer ease of use in terms of project configurability but it is only limited to the specific IDE development platform 120, 121, 122, 123.

However, when presented with a common hardware microservice such as, a hardware microservice that provide service like Random Number Generator (RNG), each software developer will have to write their own access configuration, custom shim layer configuration and software drivers, etc. within their own confined configuration of the respective IDE 110, 111, 112, 113. Software developers often faced issues such as finding the right libraries 130, 131, 132, 133 dependencies, appropriate abstractions, etc. to include, searching for resolving compilation dependencies and so on.

As can be seen in FIG. 1 in today's software development situation, each software developer will have to use its own IDE 110, 111, 112, 113 to develop codes with different IDE configuration and dependent libraries 130, 131, 132, 133, for example. The integration and manageability of various libraries 130, 131, 132, 133 to a common hardware microservice often time a heavy-lifting task. The curly lines literally meant difficult and different paths to take in order to access a common hardware microservice, such like TPM RNG. The example given in FIG. 1, can be described such that a software developer needs different layers of configuration, or different sets of combined libraries and native (not distributable and not interoperable) definition construct, in their own IDE 110, 111, 112, 113 of choice, in order to tap into a hardware microservice.

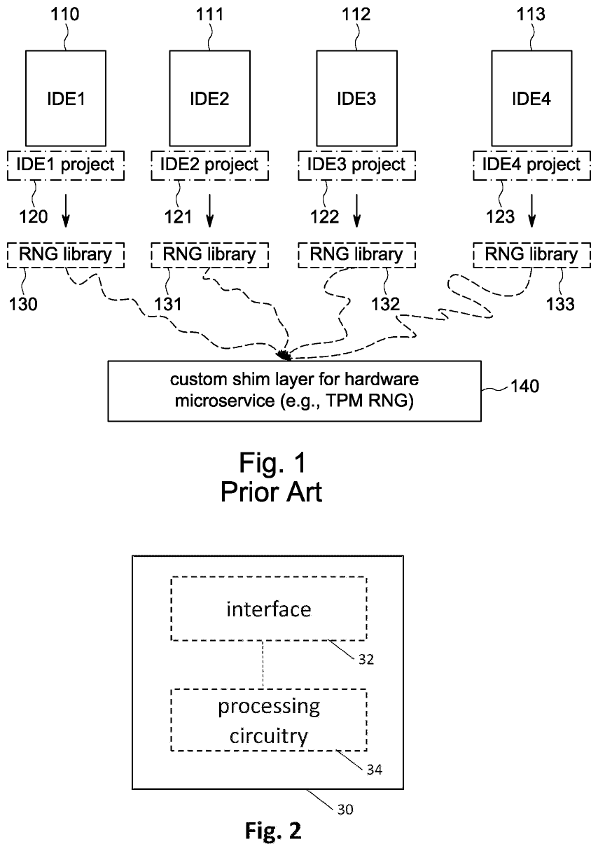

Thus, the application software development community is facing an uphill task to improve an accessibility of hardware microservices to different IDEs, e.g., by an IDE-independent configuration, and to be pass around the IDE-independent configuration. Especially to the aforementioned problem of lacking a unified method for application software developer to seamlessly integrate hardware microservices to be consumed by IDE the processing circuitry described with reference to FIG. 2 resolves among other things this issue and enables an accessibility for each IDE to all hardware microservices of a processing unit. This way, each IDE user has no need to build their own configuration or native definition (construct) anymore. Rather, the IDE-independent configuration of a particular hardware microservice can be utilized, e.g., to share a configuration which is IDE independent.

FIG. 2 shows a block diagram of an example of a processing module 30. The processing module 30 comprises one or more interfaces 32 configured to communicate with at least one integrated development environment and a processing circuitry 34 configured to control the one or more interfaces 32. Further, the processing circuitry 34 is configured to obtain information about at least one hardware microservice of a processing unit and to adapt the information about the at least one hardware microservice to a universal format for informing the at least one IDE about the at least one hardware microservice. Further, the processing circuitry 34 is configured to provide the at least one IDE access to the at least one hardware microservice. Thus, a universal, unique access to the at least one hardware microservice can be provided, e.g., to a plurality of different IDEs.

For example, a hardware microservice, which is normally configured to be used only by a first IDE can be accessed by a second IDE by adapting the information about the at least one hardware microservice. This way, the at least one hardware microservice of the processing unit can be used by each user, e.g., an application software developer. For example, a unified access for the application software developer to seamlessly integrate the at least one hardware microservice can be provided by the universal format.

For example, the universal format may be a data format which can be interpreted/accessed by a plurality of IDEs known from other system. For example, a need to find a driver for the at least one hardware microservice for a special IDE can be omitted, since the at least one hardware microservice can be accessed by a plurality of IDEs by the universal format. For example, the universal format can be widely accepted or distributed for a plurality of IDEs known form other system. For example, the universal format may be at least accepted as an industry standard or best practice.

The processing module 30 may enable an easy access to the at least one hardware microservice. Thus, a seamless implementation of different hardware microservices (e.g., a first hardware microservice corresponding to a first IDE and a second hardware microservice corresponding to a second IDE) into an application software development cycle can be achieved. The processing module 30 may establish a hardware microservice featured tunnel aimed to provide an application software user an easy method to administrate the at least one hardware microservice modeling and representation. This featured tunnel may be provided by adapting the information about the at least one hardware microservice to the universal format and by providing access to the at least one hardware microservice.

For example, for a plurality of hardware microservices a (compelling) set of hardware microservices can be generated by adapting the information about the plurality of hardware microservices to the universal format. This may power a collection of the plurality of hardware microservices, e.g., by changing a design paradigm of a user, e.g., a silicon designer, to design hardware microservice adhering to the agnostic hardware microservices modeling representation requirement, e.g., the requirement of the universal format. Further, the collection of the plurality of hardware microservices may also pull the segregation of the different hardware microservices, e.g., used by the software development community, into harmony. Thus, by using the universal format an agnostic concept for accessing the at least one hardware microservice/plurality of hardware microservices, especially of different silicon designers/hardware microservice developer, can be achieved.

In an example, the processing circuitry 34 may be further configured to generate a meta data construct comprising the information about the hardware microservice and to provide the at least one IDE access to the hardware microservice by providing access to the meta data construct.

For example, the processing module 30 may provide a meta-framework (e.g., the meta data construct) for, e.g., design, declaration, instantiation, modelling, implementation of the at least one hardware microservice, etc. which can be recognized by different IDEs. For example, the processing module 30 may be configured to provide a software development kit (SDK). The SDK may provide hardware configuration via the meta-framework to provide access to all hardware microservices of (including the at least one hardware microservice) of the processing unit. The SDK may be capable to seed the at least one hardware microservice via a platform agnostic model with the underlying meta-framework.

In an example, the meta data construct may expose a core and/or a nucleus of the at least one hardware microservice for the at least one IDE. For example, the processing module 30 may provide a method (e.g., a software solution) capable of creating a common platform where a seed of the at least one hardware microservice can be abstracted (e.g., by the meta data construct), such that they can be used by each IDE. Especially, a virtualization of a core and/or a nucleus of the at least one hardware microservice and/or an exposition of the at least one hardware microservice in a software configurable method can be achieved by the method (e.g., the software solution). For example, a configuration file can be generated (e.g., by the software solution) and can be absorbed/interpreted by different software languages, e.g., the adapted information can be used by different IDEs.

The processing module 30 can provide the meta-framework (e.g., the meta data construct) that can be exchanged across different development platforms. Thus, a scalability and manageability can be improved, e.g., by use of the meta data construct. For example, a project design file or a package difficult to maintain and shared in a cross-collaboration mode in a complex and vastly distributed development team across different locations can be avoided.

The processing module 30, e.g., the meta data construct, may comprise a unified meta-framework for design, modelling and implementation of the at least one hardware microservice which can be recognized by the at least one IDE (and all other IDEs). This unified meta-framework may promote the at least one hardware microservice as a nucleus of a configuration and it may be IDE agnostic (can be used for a plurality of IDEs). Especially, the universal format can be combined with each IDE known from other systems. Further, the processing module 30 may provide a universal contractual meta framework solution so that all users (e.g., application software developer) using their own IDE can access the at least one hardware microservice without worrying about IDE compatibility issue, since the universal format provides access for all IDEs. This way, the at least one hardware microservice can be accessed by each user (independently of a used IDE).

For example, the processing module 30 may be used to create a common platform where the definitions of the at least one hardware microservice can be abstracted. Thus the nucleus of the at least one hardware microservice can be modeled and/or provisioned. Further, the processing module 30 may be used to widely proliferated by the user, e.g., a software community, and consumed by different IDEs. The processing module 30 may provide a technical apparatus for a user to expand and extend a used software capability reaching to the at least one hardware microservice regardless of the development platform right at the beginning of the product development, and especially not as an after-thought. The processing module 30 may further provide a stable, robust and non-repudiation of origin the at least one hardware microservice orchestration, choreography and/or curation over a long period of time. This way, the processing module 30 may enable the user to fully access/use the at least one hardware microservice/all hardware microservices of the processing unit, which may leverage a performance and/or may increase a user experience.

For example, the processing module 30 may enable a user to use an IDE shared configuration, a (software) configurable meta data construct, an IDE unification, a software configuration engine, etc. Especially, the processing module 30 may be capable to generate a software language independent configuration to abstract the at least one hardware microservice. Thus, a user e.g., a software application developer, may be enabled to pass around a configuration file for tapping into the at least one hardware microservice.

As shown in FIG. 2 the respective one or more interfaces 32 are coupled to the respective processing circuitry 34 at the processing module 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the one or more interfaces 32, so that any data transfer that occurs over the one or more interfaces 32 and/or any interaction in which the one or more interfaces 32 may be involved may be controlled by the processing circuitry 34.

In an example the processing module 30 may comprise a memory and at least one processing circuitry 34 operably coupled to the memory and configured to perform the below mentioned method.

In examples the one or more interfaces 32 may correspond to any means for obtaining, receiving, transmitting or providing analog or digital signals or information, e.g. any connector, contact, pin, register, input port, output port, conductor, lane, etc. which allows providing or obtaining a signal or information. The one or more interfaces 32 may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described below. The example shown in FIG. 2 may comprise one or more optional additional features corresponding to one or more aspects mentioned in connection with the proposed concept or one or more examples described below (e.g., FIG. 3-10).

FIG. 3 shows an example of accessing a desired hardware microservice 340. To provide access for a plurality of IDEs 110, 111, 112, 113 to the at least one hardware microservice a unified meta data structure 320 can be utilized, e.g., a software development via a meta framework. Using the unified meta data structure a seed of the at least one hardware microservice can be abstracted. This way it can be handed to various IDE 110, 111, 112, 113 effortlessly. Instead of using a development platform (e.g., a development kit) assigned only to a specific IDE 110, 111, 112, 113 known from other systems (see FIG. 1) the meta data structure for the at least one hardware microservice 320 can be used for each IDE 110, 111, 112, 113. The meta data structure 320 for the at least one hardware microservice may enable an access to each hardware microservice 330 of a processing unit such that the IDE 110, 111, 112, 113 may be enabled to access a desired hardware microservice 340 (e.g., TPM RNG). This way, the meta data structure 320 for the at least one hardware microservice 320 may allow a core and/or a nucleus of the desired hardware microservice 340 to be exposed to every user regardless of the IDE 110, 111, 112, 113 of choice.

As described above (with reference to FIG. 2) the processing module is capable to generate a software/software language, which can be used as a common platform where a seed of the at least one hardware microservice can be abstracted via a software configurable meta framework (e.g., the meta data construct). This software configuration can provide a core and/or a nucleus of the at least one hardware microservice to be modeled and consumed by any user. This meta data structure 320 can also be widely proliferated by the software development community and consumed by different IDEs.

In an example, the meta data structure 320 is a data structure 320. The data structure 320 comprises information about at least one hardware microservice of a processing unit, wherein the information comprises a universal format for informing the at least one IDE about the hardware microservices. The data structure 320 may comprise all information needed to provide access for each IDE to the at least one hardware microservice.

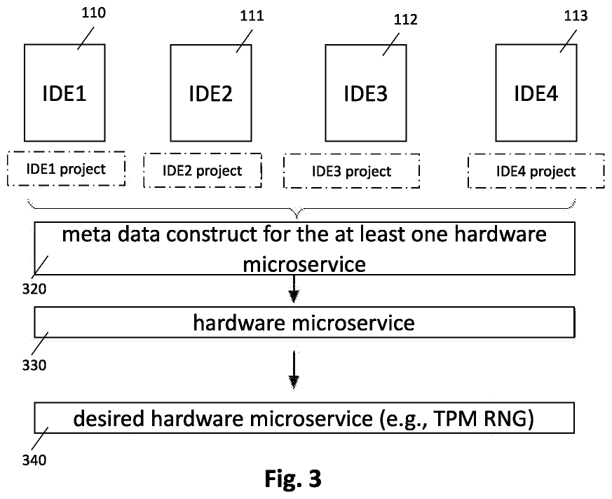

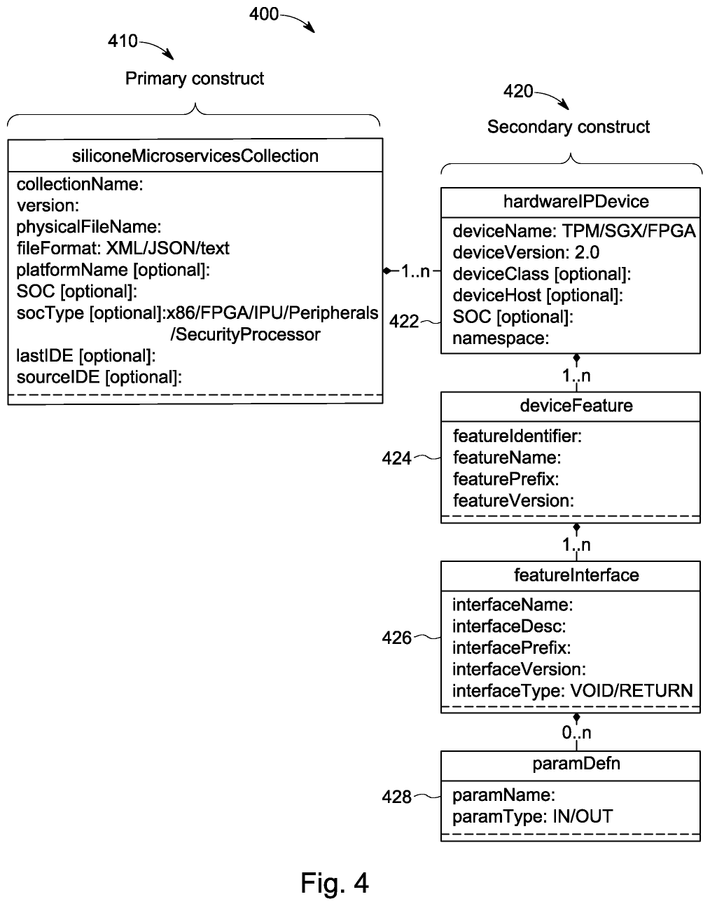

An example of the meta data structure 320 (data structure) is described in greater detail with reference to FIG. 4.

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIG. 2) and/or below (e.g., FIG. 4-10).

FIG. 4 shows an example of a meta framework 400, the meta data construct 400. The meta data construct 400 may be built upon two entities, namely a primary construct 410 and a subconstruct 420 comprising at least one secondary construct 422, 424, 426, 428.

The meta data construct 400 may contain unique properties to be further populated with some specific mandatory data and may be recognized by all IDEs. This meta data construct 400 may exist as a form of a configuration framework. The meta data construct 400 may also comprise at least one subconstruct 420 in a one-to-many relationship to the primary construct 410, the secondary construct 422, 424, 426, 428. For example, the subconstruct 420 may comprise a plurality of secondary constructs 422,424, 426, 428.

The meta data construct 400 may comprise a description of how the at least on hardware microservice can be implemented, e.g., native IDE such like java, swift, etc. can consume the meta data construct 400, can load the meta data construct 400 and/or the at least one hardware microservice can be available using the meta data construct 400.

In an example, the meta data construct 400 may comprise a primary construct 410. The Primary construct 410 may be to identify the at least one hardware microservice, e.g., to identify a collection of a plurality of hardware microservice, which may be available for a user, e.g., an application software developer. For example, the primary construct 400 may serve as a root class. The primary construct 410 (the root class) may be used to start a definition of the at least one hardware microservice, e.g., to provide a framework for common (silicone) hardware microservices.

In an example, a parent of the primary construct 410 may be none. For example, the primary construct may be a super parent class, or an object where the definition of the at least one hardware microservice starts. In an example, a cardinality of the primary construct 410 may be singleton.

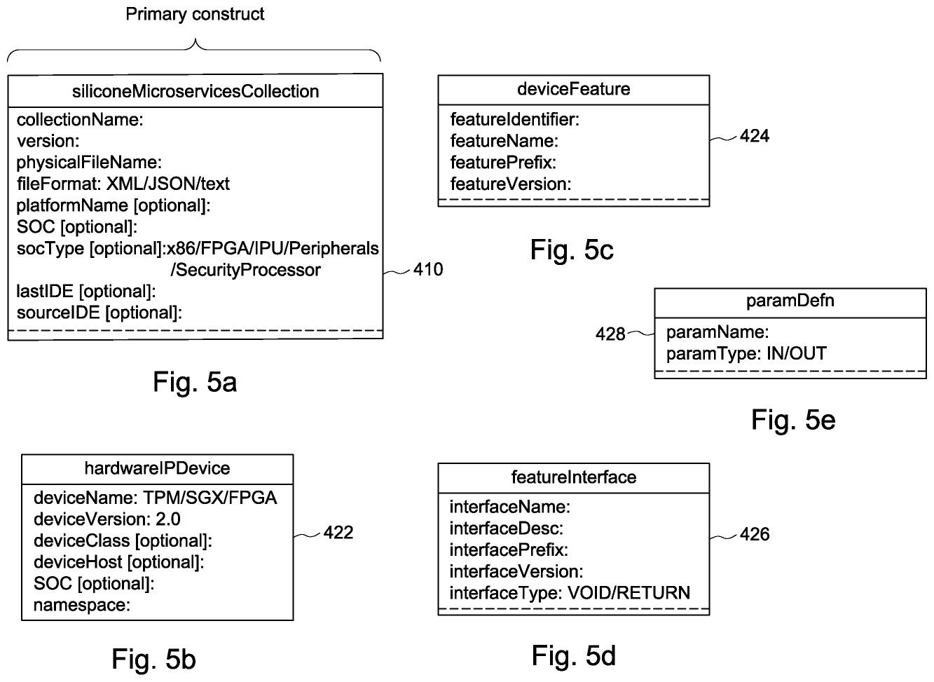

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIG. 2-3) and/or below (e.g., FIG. 5-10).

FIG. 5a-5e show properties within the primary construct 410 and the secondary constructs 422, 424, 426, 428.

As can be seen in FIG. 5a the primary construct 410 may be used to identify at least one hardware microservice/plurality of hardware microservices available to a user, e.g., an application software developer. For example, the primary construct 410 may be used to identify a collection of all available hardware microservices of a processing unit. As mentioned, the primary construct 410 may serve as a root class where the definition of the at least one hardware microservice/plurality of hardware microservices starts. A parent to this primary construct 410 may be none. Further, it may be a super parent class, or an object where the definition of the at least one hardware microservice/plurality of hardware microservices starts. The cardinality may be singleton because 410 is the root. For example, the primary construct 410 may be a siliconeMicroservicesCollection construct 410.

In an example, the primary construct 410 may comprise information about at least one element of the group of a collection name (e.g., of a collection comprising a plurality/all hardware microservices of a processing unit), a version (of the meta data construct 400), a physical file name and a file format. For example, as summarized in Tab. 1 the siliconeMicroservicesCollection construct 410 may comprise at least one mandatory field, e.g., to expose a core and/or a nucleus of the corresponding hardware microservice. Optionally, the siliconeMicroservicesCollection construct 410 may comprise at least one optional field, e.g., to provide information about a usage of the at least one hardware microservice.

TABLE 1
Example of a primary construct 410 (siliconeMicroservicesCollection construct)

| Class Name | siliconeMicroserviceCollection | | |
|---|---|---|---|
| Description | Root class where the definition of the common silicone (HW) | | |
| | microservice framework starts. | | |
| Parent | Super parent class or object where the definition starts | | |
| Cardinality | Singleton | | |
| Attributes | Type | Cardinality | Description |
| collectionName: | character | Mandatory | Name of the project of framework. |
| version: | character | Mandatory | Current revision of the model or |
| | | | framework. |
| physicalFileName: | character | Mandatory | Name of the project file. |
| fileFormat: | enumeration | Mandatory | Enumeration of file format - |
| | | | XML/JSON/text |
| platformName | character | Optional | Name of the hardware platform (ir |
| [optional]: | | | any) where the particular device or |
| | | | silicone is hosted. |
| SOC: | character | | Name of the SOC/FPGA/custom- |
| | | | ASIC device |
| socType [optional]: | enumeration | Optional | Type of silicone - |
| | | | x86/FPGA/IPU/Peripherals/ |
| | | | SecurityProcessor |
| lastIDE: | character | Optional | The most recent application devel- |
| | | | opment platform used to edit/mod- |
| | | | ify the model |
| sourceIDE: | character | Optional | The first or initial application de- |
| | | | velopment platform used to create |
| | | | the first version of the model. |

The parameters/fields of Tab. 1 of the example of the siliconeMicroservicesCollection construct 410 may be as follow:
The connectionName may be a mandatory field and a character type, which can be used to describe the name of a project and/or the meta framework (e.g., the meta data construct 400).
The version may be a mandatory field, a character type, which can be used to describe a current revision of the meta data construct 400 and/or the meta framework.
The physicalFieldName may be a mandatory field, a character type, which can be used to describe a name of a project file.
The fileFormat may be a mandatory field, a character type, which can be used to describe an enumeration of a file format, such as XML, JSON, text, etc.
The platformName may be an optional field, a character type, which can be used to describe a name of the hardware platform, e.g., the processing unit, where the specific device is hosted, such as Bay Trail (BYT), ELL, etc.
The SOC may be a mandatory field, a character type, which can be used to describe the name of the SOC such as SOC, Field-Programmable Gate Array (FPGA), custom ASIC, etc.
The socType may be an optional field, an enumeration, which can be used to describe the type of the processing unit. Such as that if this is a x86, FPGA, IPU, peripheral, etc.
The lastIDE may be an optional field, containing information such as the most recent application development platform used to edit or modify the meta data construct 400.
The sourceIDE may be an optional field, containing information such as the first, or initial application development platform used to create the first version of the meta data construct 400.

In an example, the primary construct 410 may comprise at least one secondary construct 422, 424, 426, 428, e.g., the secondary construct 422 shown in FIG. 5b. FIG. 5b shows an example of the secondary construct 422 that describes the at least one hardware microservice. The cardinality of the primary construct 410 to the secondary construct 422 may be one-to-many relationship.

In an example, the secondary construct 422 of the at least one secondary construct 422, 424, 426, 428 may provide information about the at least one hardware microservice. For example, the secondary construct 422 may be a hardwareIPDevice construct 422. The hardwareIPDevice construct 422 may operate to provide an identification of the at least one hardware microservice. In an example, the primary construct 410 may be a parent of the at least one secondary construct. For example, the parent of the hardwareIPDevice construct 422 may be the siliconeMicroservicesCollection construct 410. Further, the hardwareIPDevice construct 422 may have a one-to-many relationship to another secondary construct 424 (e.g., a deviceFeature construct 424 shown in FIG. 5c). As can be seen in FIG. 4 for the meta data construct 400, in systems analysis, a one-to-many relationship is a type of cardinality that refers to the relationship between two entities A (e.g., the primary construct 410) and B (e.g., the plurality of secondary construct 422, 424, 426, 428) in which an element of A may be linked to many elements of B, but a member of B is linked to only one element of A.

For example, as summarized in Tab. 2 the hardwareIPDevice construct 422 may comprise at least one mandatory field, e.g., to describe a version of the at least one hardware microservice. Optionally, the hardwareIPDevice construct 422 may comprise at least one optional field, e.g., to provide information about an identifier of the at least one hardware microservice.

TABLE 2
Example of a secondary construct 422 (hardwareIPDevice construct 422) comprising
information about an identification of the at least one hardware microservice.

| Class Name | hardwareIPDevcie | | |
|---|---|---|---|
| Description | The identification of the silicone (hardware) device | | |
| Parent | siliconeMicroserviceCollection | | |
| Cardinality | one-to-many | | |
| Attributes | Type | Cardinality | Description |
| deviceName: | character | Mandatory | Name or identify of the silicone or |
| | | | device |
| deviceVersion: 2.0 | character | Mandatory | Version of the device. |
| deviceClass | character | Optional | Unique identifier of the device or |
| [optional]: | | | alternate name. |
| deviceHost: | character | Optional | Host name where the device could be |
| | | | hosted, i.e. name of the platform or CPU |
| SOC [optional]: | character | Optional | Nam of the SOC/PFGA/Custom-ASIC |
| | | | device |
| namespace: | character | Mandatory | Unique naming to identify and refer to |
| | | | objects in the software implementations, |
| | | | i.e. com.intel.oneapi.tpm20 |

The parameters/fields of Tab. 2 of the example of the hardwareIPDevice construct 422 may be as follow:
The deviceName may be a mandatory field, a character type, which can be used to describe a name and/or identify a processing unit of a device, e.g., the processing unit, such as a TPM, an Intel SGX, a FPGA, etc.
The deviceVersion may a mandatory field, a character type to describe a version of the device, e.g., such as 2.0 for TPM specifically, or in the event no version defined it may be defaulted as 1.0.
The deviceClass may be an optional field, a character type, which can be used to describe the unique identifier of the device or to provide an alternat name.
The deviceHost may be an optional field, a character type to describe the host name where the device could be hosted. Such as the name of the platform or a central processing unit.
The SOC may be an optional field, a character type, which can be used to describe the name of the SOC such as SOC, FPGA, etc.
The nameSpace may be a mandatory field, a character type to provide a unique naming to identify and/or refer to objects in a software implementation such as com.intel.oneapi.tpm20.

FIG. 5c shows another example of a secondary construct 424 that describes a device (e.g., the processing unit) interface for the at least one hardware microservice.

In an example, a second secondary construct 424 of the at least one secondary construct 422, 424, 426, 428 may provide a definition of a soft (e.g., a general logic unit in the fabric within the FPGA, which can be reprogrammed) and/or hard (e.g., hard-wired logics in the silicon) functionality of the hardware microservice. For example, a functionality may be provided by a type of hardware implementation. For example, the second secondary construct 424 may be a deviceFeature construct 424. The deviceFeature construct 424 may operate to provide a definition of a soft and/or hard intellectual property (IP) feature/functionality of the processing unit. The parent of the deviceFeature construct 422 may be the hardwareIPDevice construct 422. Further, the deviceFeature construct 422 may have a one-to-many relationship to another secondary construct 426 (e.g., a featureInterface construct 426 as shown in FIG. 5d).

For example, as summarized in Tab. 3 the deviceFeature construct 424 may comprise at least one mandatory field, e.g., to describe an identifier of the meta data construct 400. Optionally, the deviceFeature construct 424 may comprise at least one optional field, e.g., to provide information about a name of the at least one hardware microservice.

TABLE 3
Another example of a secondary construct 424 (deviceFeature construct 424) comprising
information about of a soft and/or hard intellectual property feature.

| Class Name | deviceFeature | | |
|---|---|---|---|
| Description | Definition of either soft or hard IP feature or functionality. | | |
| Parent | hardwareIPDevice | | |
| Cardinality | one-to-many | | |
| Attributes | Type | Cardinality | Description |
| featureIdentifier: | character | Mandatory | Unique identifier or method call name of |
| | | | the feature or functionality to be |
| | | | instantiated. |
| featuerName: | character | Mandatory | Name or description of the feature or |
| | | | functionality. |
| featurePrefix: | character | Optional | CodeName, short nahme or prefix of the |
| | | | feature or functionality. |
| featureVersion: | character | Optional | Version of the feature or functionality. |

The parameters/fields of Tab. 3 of the example of the deviceFeature construct 424 may be as follow:
The featureIdentifier may be a mandatory field, a character type, which can be used to describe a unique identifier or a meta data structure call name of a feature/functionality of the at least one hardware microservice to be instantiated.
The featureName may be a mandatory field, a character type, which can be used and to describe a name or a description of the feature or the functionality of the at least one hardware microservice.
The featurePrefix may be an optional field, a character type and may describe a code name, a short name or prefix of the feature or functionality of the at least one hardware microservice.
The featureVersion may be an optional field, a character type, which can be used to provide a version of the feature or functionality of the at least one hardware microservice.

FIG. 5d shows another example of a secondary construct 426 that describes properties of the feature interface construct 424.

In an example, a third secondary construct 426 of the at least one secondary construct 422, 424, 426, 428 may provide a collection of functionalities of the at least one hardware microservice. For example, the third secondary construct 426 may be a featureInterface construct 426. The featureInterface construct 426 may operate to describe a definition of a soft and/or hard intellectual property (IP) feature/functionality of the processing unit. For example, there could be more than one interface offered for a device feature, e.g., for the at least one hardware microservice. The parent of the featureInterface construct 426 may be the deviceFeature construct 424. Further, the featureInterface construct 426 may have a one-to-many relationship to another secondary construct 428 (e.g., a paramDefn construct 428 as shown in FIG. 5e).

For example, as summarized in Tab. 4 the featureInterface construct 426 may comprise at least one mandatory field, e.g., to provide information about an interface.

TABLE 4
Another example of a secondary construct 426 (featureInterface construct 426)
comprising information about properties of a feature interface.

| Class Name | featureInterface | | |
|---|---|---|---|
| Description | Collection of the feature(s) published by the hard or soft IP device. | | |
| | There could be more than one interface offered for a device feature. | | |
| Parent | deviceFeature | | |
| Cardinality | one-to-many | | |
| Attributes | Type | Cardinality | Description |
| interfaceName: | character | Mandatory | Unique identifier or name of the |
| | | | interface provisioned for a feature. |
| interfaceDesc: | character | Mandatory | Name or description of the interface. |
| interfacePrefix | character | Mandatory | Code name, short name or prefix. |
| interfaceVersion | character | Mandatory | Version of the interface. |
| interfaceType: | enumeration | Mandatory | Enumeration type of the interface. |
| | | | VOID/RETURN |

The parameters/fields of Tab. 4 of the example of the featureInterface construct 426 may be as follow:
The interfaceName may be a mandatory field, a character type, which can be used to describe a unique identifier or name of the interface provisioned for a feature/functionality of the hardware microservice.
The interfaceDesc may be a mandatory field, a character type, which can be used to describe a name or description of the interface.
The interfacePrefix may be a mandatory field, a character type, which can be used to describe a code name, a short name or a prefix.
The interfaceType may be a mandatory field, an enumeration type for enumerating the type of the interface. For example, VOID or RETURN.

FIG. 5e shows another example of a secondary construct 428 that describes a collection of in and out parameters for an interface.

In an example, a fourth secondary construct 428 of the at least one secondary construct 422, 424, 426, 428 may provide a collection of in and/or out parameters for the collection of functionalities. For example, the fourth secondary construct 428 may be a paramDefn construct 428. The paramDefn construct 428 may operate to describe a collection of in and out parameters for an interface. The parent of the paramDefn construct 428 may be the featureInterface construct 426. Further, the paramDefn construct 428 may have a zero-to-many relationship. Further, the paramDefn construct 428 may be a last construct.

For example, as summarized in Tab. 5 the paramDefn construct 428 may comprise at least one mandatory field, e.g., to provide information about a parameter used for implementing the meta data construct 400.

TABLE 5
Another example of a secondary construct 426 (featureInterface construct 426)
comprising information about a collection of in and out parameters for an interface.

| Class Name | paramDefn | | |
|---|---|---|---|
| Description | Collection of the IN or OUT parameter(s) for an interface. | | |
| Parent | featureInterface | | |
| Cardinality | one-to-many | | |
| Attributes | Type | Cardinality | Description |
| paramName: | character | Mandatory | Name of the parameter used in the |
| | | | implementation |
| paramType: | enumeration | Mandatory | Enumeration type of the parameter: |
| | | | IN/OUT. |

The parameters/fields of Tab. 5 of the example of the paramDefn construct 428 may be as follow:
The paramName may be a mandatory field, a character type, which can be used to describe the name of a parameter (e.g., an in or out parameter) used in the implementation.
The paramType may be a mandatory field, an enumeration type to enumerate the type of the parameter, such as whether this is an in or out parameter.

This meta data structure can be shared amongst different types of IDE. For example, the meta data structure may be IDE independent. Further, the IDE may contain key information to formulate abstraction to the at least one hardware microservice.

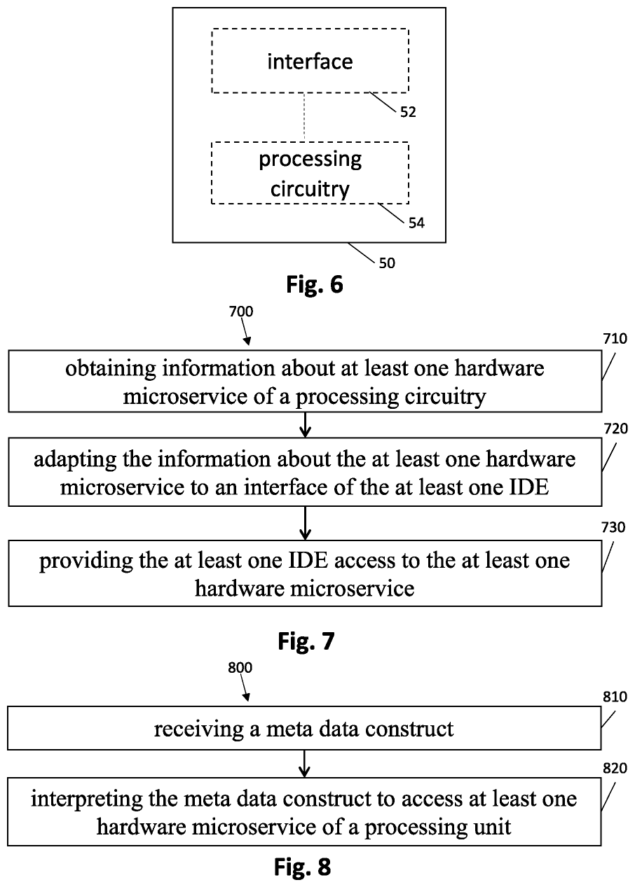

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIG. 2-4) and/or below (e.g., FIG. 6-10).

FIG. 6 shows an example of a block diagram of an integrated development environment 50. The integrated development environment comprises one or more interfaces 52 configured to communicate with at least one processing module (e.g., the processing module as described above, e.g., with reference to FIG. 3) and processing circuitry 54 configured to control the one or more interfaces 52. Further, the processing circuitry 54 is configured to receive a meta data construct and to interpret the meta data construct to access at least one hardware microservice of a processing unit. For example, the IDE 50 may be a counterpart to the processing module described above. The IDE 50 may receive the meta data construct, which was generated by the processing module as described above.

In an example, the meta data construct may comprise information about a plurality of hardware microservices, wherein at least two hardware microservices of the plurality of hardware microservices have a different interface to communicate with a different IDE. For example, e.g., a first hardware microservice may correspond to a first IDE and a second hardware microservice may correspond to a second IDE. By use of the meta data construct the IDE 50 may enabled to use both microservices even if the plurality of hardware microservices comprises a plurality of different interfaces from other systems. By utilizing the universal format, e.g., by the meta data construct the IDE 50 can access each hardware microservice of the plurality of hardware microservices.

In an example, the processing circuitry 54 may be further configured to interpret a primary construct of the meta data construct of the processing module to access the at least one hardware microservice. Thus, the IDE 50 can access the meta data construct, e.g., a collection of the plurality of hardware microservices.

In an example, the processing circuitry 54 may be further configured to interpret a second construct to access a functionality of the at least one hardware microservice. Thus, the IDE 50 can utilize all capabilities (e.g., describe especially with reference to FIG. 5) of the meta data construct.

As shown in FIG. 6 the respective one or more interfaces 52 are coupled to the respective processing circuitry 54 at the IDE 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the one or more interfaces 52, so that any data transfer that occurs over the one or more interfaces 52 and/or any interaction in which the one or more interfaces 52 may be involved may be controlled by the processing circuitry 54.

In an example the IDE 50 may comprise a memory and at least one processing circuitry 54 operably coupled to the memory and configured to perform the below mentioned method.

In examples the one or more interfaces 52 may correspond to any means for obtaining, receiving, transmitting or providing analog or digital signals or information, e.g. any connector, contact, pin, register, input port, output port, conductor, lane, etc. which allows providing or obtaining a signal or information. The one or more interfaces 52 may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIG. 2-5) and/or below (e.g., FIG. 7-10).

FIG. 7 shows an example of a method 700. The method 700 comprises obtaining 710 information about at least one hardware microservice of a processing unit, adapting 720 the information about the at least one hardware microservice to an interface of the at least one IDE and providing 730 the at least one IDE access to the at least one hardware microservice. For example, the method 700 may be performed by the processing module as described above.

In an example, the method may further comprise generating a meta data construct comprising the at least one hardware microservice and providing the at least one IDE access to the at least one hardware microservice by providing access to the meta data construct.

The method can be performed by a software model, which may run on the processing unit or the processing module. The software model can provide a meta framework (e.g., the meta data construct) that can be exchanged across different development platforms. Thus, a scalability and manageability can be improved by the software model, e.g., by the meta data construct. For example, project design files or package difficult to maintain and shared in cross collaboration mode in a complex and vastly distributed development teams across different locations can be avoided. Issues such as, e.g., missing definitions, namespace, object declarations, instantiations in managing the software layers, etc. can be avoided. Further, the software layers known from other systems cannot scale towards different IDE thus preventing cross collaboration and wide proliferation. By utilizing the software model a cross collaboration may be enabled. Further, a duplication can be eased and/or an expense to maintain can be reduced.

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIG. 2-6) and/or below (e.g., FIG. 8-10).

FIG. 8 shows an example of a method 800 for an IDE. The method 800 comprises receiving 810 a meta data construct and interpreting 820 the meta data construct to access at least one hardware microservice of a processing unit. The method 800 may be performed by an IDE as described above (e.g., with reference to FIG. 6), for example.

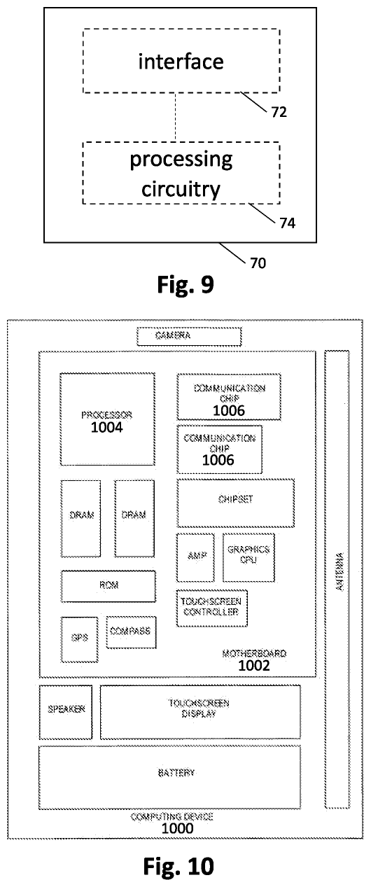

More details and aspects are mentioned in connection with the examples described above and/or below. The example shown in FIG. 8 may comprise one or more optional additional features corresponding to one or more aspects mentioned in connection with the proposed concept or one or more examples described above (e.g., FIG. 2-7) and/or below (e.g., FIG. 9-10).

FIG. 9 shows an example of a processing unit 70. The processing unit 70 comprises one or more interfaces 72 configured to communicate with at least one integrated development environment; and processing circuitry 74 configured to control the one or more interfaces 72 and to generate the (meta) data structure as described above, e.g., as described with reference to FIG. 3-5. For example, the processing unit 70 may be configured to generate the meta data structure which ban be utilized by each IDE and/or shared between different users.

As shown in FIG. 9 the respective one or more interfaces 72 are coupled to the respective processing circuitry 74 at the processing unit 70. In examples the processing circuitry 74 may be implemented using one or more processing units, one or more processing devices, any means for processing, such as a processor, a computer or a programmable hardware component being operable with accordingly adapted software. Similar, the described functions of the processing circuitry 74 may as well be implemented in software, which is then executed on one or more programmable hardware components. Such hardware components may comprise a general-purpose processor, a Digital Signal Processor (DSP), a micro-controller, etc. The processing circuitry 74 is capable of controlling the one or more interfaces 72, so that any data transfer that occurs over the one or more interfaces 72 and/or any interaction in which the one or more interfaces 72 may be involved may be controlled by the processing circuitry 74.

In an example the processing unit 70 may comprise a memory and at least one processing circuitry 74 operably coupled to the memory and configured to perform the below mentioned method.

In examples the one or more interfaces 72 may correspond to any means for obtaining, receiving, transmitting or providing analog or digital signals or information, e.g. any connector, contact, pin, register, input port, output port, conductor, lane, etc. which allows providing or obtaining a signal or information. The one or more interfaces 72 may be wireless or wireline and it may be configured to communicate, e.g., transmit or receive signals, information with further internal or external components. The one or more interfaces 72 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 9 may comprise one or more optional additional features corresponding to one or more aspects mentioned in connection with the proposed concept or one or more examples described above (e.g., FIG. 2-8) and/or below (e.g., FIG. 10).

FIG. 10 shows a computing device 1000. The computing device 1000 houses a board 1002. The board 1002 may include a number of components, including but not limited to a processor 1004 and at least one communication chip 1006. A processing module as described above (e.g., with reference to FIG. 2) or an IDE as described above (e.g., with reference to FIG. 6) may be comprised by the processor 1004 as shown in FIG. 10.

The processor 1004 is physically and electrically coupled to the board 1002. In some examples the at least one communication chip 1006 is also physically and electrically coupled to the board 1002. In further examples, the communication chip 1006 is part of the processor 1004.

Depending on its applications, computing device 1000 may include other components that may or may not be physically and electrically coupled to the board 1002. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some examples, the integrated circuit die of the processor includes one or more devices that are assembled in an ePLB or eWLB based POP package that that includes a mold layer directly contacting a substrate, in accordance with examples. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another example, the integrated circuit die of the communication chip includes one or more devices that are assembled in an ePLB or eWLB based POP package that that includes a mold layer directly contacting a substrate, in accordance with examples.

More details and aspects are mentioned in connection with the examples described above. The example shown in FIG. 10 may comprise one or more optional additional features corresponding to one or more aspects mentioned in connection with the proposed concept or one or more examples described above (e.g., FIG. 2-10).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

An example (e.g., example 1) relates to a processing module, comprising one or more interfaces configured to communicate with at least one integrated development environment, IDE, and processing circuitry configured to control the one or more interfaces and to obtain information about at least one hardware microservice of a processing unit, adapt the information about the at least one hardware microservice to a universal format for informing the at least one IDE about the at least one hardware microservice and provide the at least one IDE access to the at least one hardware microservice.

Another example (e.g., example 2) relates to a previously described example (e.g., example 1) wherein the processing circuitry is further configured to generate a meta data construct comprising the information about the at least one hardware microservice and provide the at least one IDE access to the at least one hardware microservice by providing access to the meta data construct.

Another example (e.g., example 3) relates to a previously described example (e.g., the example 2) wherein the meta data construct exposes a core and/or a nucleus of the microservice for the at least one IDE.

Another example (e.g., example 4) relates to a previously described example (e.g., one of the examples 2-3) wherein the meta data construct comprises a primary construct.

Another example (e.g., example 5) relates to a previously described example (e.g., the example 4) wherein a parent of the primary construct is none.

Another example (e.g., example 6) relates to a previously described example (e.g., one of the examples 4-5) wherein the primary construct serves as root class.

Another example (e.g., example 7) relates to a previously described example (e.g., one of the examples 4-6) wherein a cardinality of the primary construct is singleton.

Another example (e.g., example 8) relates to a previously described example (e.g., one of the examples 4-7) wherein the primary construct comprises information about at least one element of the group of a collection name, a version, a physical file name and a file format.

Another example (e.g., example 9) relates to a previously described example (e.g., one of the examples 4-8) wherein the primary construct comprises at least one secondary construct.

Another example (e.g., example 10) relates to a previously described example (e.g., the example 9) wherein the primary construct is a parent of the at least one secondary construct.

Another example (e.g., example 11) relates to a previously described example (e.g., one of the examples 9-10) wherein a secondary construct of the at least one secondary construct provides information about the at least one hardware microservice.

Another example (e.g., example 12) relates to a previously described example (e.g., the example 11) wherein a second secondary construct of the at least one secondary provides a definition of a soft and/or hard functionality of the at least one hardware microservice.

Another example (e.g., example 13) relates to a previously described example (e.g., the example 12) wherein a third secondary construct of the at least one secondary construct provides a collection of functionalities of the at least one hardware microservice.

Another example (e.g., example 14) relates to a previously described example (e.g., the example 13) wherein a fourth secondary construct of the at least one secondary construct provides a collection of in and/or out parameters for the collection of functionalities.

An example (e.g., example 15) relates to an integrated development environment, IDE, comprising one or more interfaces configured to communicate with at least one processing module and processing circuitry configured to control the one or more interfaces and to receive a meta data construct and interpret the meta data construct to access at least one hardware microservice of a processing unit.

Another example (e.g., example 16) relates to a previously described example (e.g., the example 15) wherein the meta data construct comprises information about a plurality of hardware microservices, wherein at least two hardware microservices of the plurality of hardware microservices have a different interface to communicate with a different IDE.

Another example (e.g., example 17) relates to a previously described example (e.g., the example 16) wherein the processing circuitry is further configured to interpret a primary construct of the meta data construct of the processing module to access the at least one hardware microservice.

Another example (e.g., example 18) relates to a previously described example (e.g., the example 17) wherein the processing circuitry is further configured to interpret a second construct to access a functionality of the at least one hardware microservice.

An example (e.g., example 19) relates to a method, comprising obtaining information about at least one hardware microservice of a processing unit, adapting the information about the at least one hardware microservice to an interface of the at least one IDE and providing the at least one IDE access to the at least one hardware microservice.

Another example (e.g., example 20) relates to a previously described example (e.g., the examples 19) further comprising generating a meta data construct comprising the at least one hardware microservice and providing the at least one IDE access to the at least one hardware microservice by providing access to the meta data construct.

An example (e.g., example 21) relates to a non-transitory, computer-readable medium comprising a program code that, when the program code is executed on a computer, a processor, or a programmable hardware component, performs one of the above examples (e.g., one of the examples 19-20)

An example (e.g., example 22) relates to a method, comprising receiving a meta data construct and interpreting the meta data construct to access at least one hardware microservice of a processing unit.

An example (e.g., example 23) relates to a non-transitory, computer-readable medium comprising a program code that, when the program code is executed on a computer, a processor, or a programmable hardware component, performs one of the above examples (e.g., the example 22)

An example (e.g., example 24) relates to a data structure, comprising information about at least one hardware microservice of a processing unit, wherein the information comprises a universal format for informing the at least one IDE about the hardware microservices.

An example (e.g., example 25) relates to a processing unit, comprising one or more interfaces configured to communicate with at least one integrated development environment, IDE; and processing circuitry configured to control the one or more interfaces and to generate the data structure as described above (e.g., according to example 24).

An example (e.g., example 25) relates to a computer program having a program code for performing the method of the above examples (e.g., one of the examples 19-20), when the computer program is executed on a computer, a processor, or a programmable hardware component.

An example (e.g., example 26) relates to a computer program having a program code for performing the method of the above examples (e.g., one of the examples 22), when the computer program is executed on a computer, a processor, or a programmable hardware component.

An example (e.g., example 27) relates to a processing module, comprising means for processing and means for storing information, wherein the processing module is configured to obtain information about at least one hardware microservice of a processing unit, adapt the information about the at least one hardware microservice to a universal format for informing the at least one IDE about the at least one hardware microservice and provide the at least one IDE access to the at least one hardware microservice.

An example (e.g., example 28) relates to an integrated development environment, IDE, comprising means for processing and means for storing information, wherein the IDE is configured to receive a meta data construct and interpret the meta data construct to access at least one hardware microservice of a processing unit.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A processing module, comprising:
one or more interfaces configured to communicate with at least one integrated development environment, IDE; and
processing circuitry configured to control the one or more interfaces and to:
obtain information about at least one hardware microservice of a processing unit;
adapt the information about the at least one hardware microservice to a universal format for informing the at least one IDE about the at least one hardware microservice; and
provide the at least one IDE access to the at least one hardware microservice.

2. The processing module according to claim 1, wherein
the processing circuitry is further configured to:
generate a meta data construct comprising the information about the at least one hardware microservice; and
provide the at least one IDE access to the at least one hardware microservice by providing access to the meta data construct.

3. The processing module according to claim 2, wherein
the meta data construct exposes a core and/or a nucleus of the microservice for the at least one IDE.

4. The processing module according to claim 2, wherein
the meta data construct comprises a primary construct.

5. The processing module according to claim 4, wherein
a parent of the primary construct is none.

6. The processing module according to claim 4, wherein
the primary construct serves as root class.

7. The processing module according to claim 4, wherein
a cardinality of the primary construct is singleton.

8. The processing module according to claim 4, wherein
the primary construct comprises information about at least one element of the group of a collection name;
a version;
a physical file name; and
a file format.

9. The processing module according to claim 4, wherein
the primary construct comprises at least one secondary construct.

10. The processing module according to claim 9, wherein
the primary construct is a parent of the at least one secondary construct.

11. The processing module according to claim 9, wherein
a secondary construct of the at least one secondary construct provides information about the at least one hardware microservice.

12. The processing module according to claim 11, wherein
a second secondary construct of the at least one secondary provides a definition of a soft and/or hard functionality of the at least one hardware microservice.

13. The processing module according to claim 12, wherein
a third secondary construct of the at least one secondary construct provides a collection of functionalities of the at least one hardware microservice.

14. The processing module according to claim 13, wherein
a fourth secondary construct of the at least one secondary construct provides a collection of in and/or out parameters for the collection of functionalities.

15. An integrated development environment, IDE, comprising
one or more interfaces configured to communicate with at least one processing module; and
processing circuitry configured to control the one or more interfaces and to:
receive a meta data construct; and
interpret the meta data construct to access at least one hardware microservice of a processing unit.

16. The IDE according to claim 15, wherein
the meta data construct comprises information about a plurality of hardware microservices, wherein at least two hardware microservices of the plurality of hardware microservices have a different interface to communicate with a different IDE.

17. The IDE according to claim 16, wherein
the processing circuitry is further configured to interpret a primary construct of the meta data construct of the processing module to access the at least one hardware microservice.

18. The IDE according to claim 17, wherein
the processing circuitry is further configured to interpret a second construct to access a functionality of the at least one hardware microservice.

19. A non-transitory, computer-readable medium comprising a program code that, when the program code is executed on a computer, a processor, or a programmable hardware component, performs obtaining information about at least one hardware microservice of a processing unit, adapting the information about the at least one hardware microservice to an interface of the at least one IDE and providing the at least one IDE access to the at least one hardware microservice.

20. Data structure, comprising
information about at least one hardware microservice of a processing unit, wherein the information comprises a universal format for informing the at least one IDE about the hardware microservices.
